(19) United States
(12) Patent Application Publication
(10) Pub. No.: US 2005/0064363 A1
(43) Pub. Date: Mar. 24, 2005

(54) Supporting base for a denture model and articulator which works in conjunction with the supporting base

(76) Inventor: Nikolaus Buchel, Liechtenstein (LI)

Correspondence Address: Hodgson Russ;Intellectual Property Law Group, One M & T Plaza, Suite 2000, Buffalo, NY, 14203-2391, US

(21) Appl. No.: 10/472,369

(22) PCT Filed: Mar. 21, 2002
(86) PCT No.: PCT/IB02/00845

(30) Foreign Application Priority Data
Mar. 21, 2001 (CH) 0527/01

(51) Int. Cl. A61C 11/00

(52) U.S. Cl. 433/60

(57) ABSTRACT

The invention relates to a base for a denture model and an articulator (15) for preparing dental prosthesis parts, such as cast inlay fillings, crowns, bridges, prosthetic dentures and the like, in which positive reproductions of teeth or rows of teeth can be fixed on a baseplate (1, 1a), guide elements comprising at least one dimensionally stable rail (5) and at least one row of pins (4) parallel thereto being formed on the baseplate (1, 1a) and forming corresponding guide surfaces at the tooth stumps during curing of a moulding material of the denture models. A particular embodiment of the articulator (15) is oriented not with respect to the temporomandibular joint, as to date, but with respect to the cusps of the teeth of the respective tooth models.

The invention relates to a base for a denture model and to an articulator according to the features of the precharacterizing clause of claim 1.

Patent Application DE-A-29 49 697 describes a method for the production of a denture model, in which positive reproductions of the tooth stumps produced from model material are detachably fixed to a prefabricated solid baseplate of a dimensionally stable plastic. Individual holes which serve as guide elements for pins, which are then immersed in the curable model material and are finally nondetachably anchored in the tooth stump, are incorporated into the baseplate. This method was improved by developments according to DE-A-3320050 (Zeiser model). Plastic baseplates which have leading sidewalls in order to be able to receive a plaster cast in the same location again even after its removal were provided.

A further development is described in DE-A-3436094 (jaw model). Pins which penetrated into the plaster cast, were fixed there and thus remained permanently in the plaster cast were provided. Opposite the pins, holes were made in a baseplate so that plaster cast parts which had been removed were replaced back again in the correct position.

These known bases for plaster casts were superseded by a subsequent development according to WO-A-88/10101 (Wohlwend model). There, the disadvantages arising from the earlier bases were recognized and a baseplate in which pins were rigidly integrated was provided so that they came to rest in the interdental spaces of the plaster casts and left behind conical holes there, in which, on reinsertion of plaster cast parts which had been removed, the correct positioning thereof on the fixed pins was ensured.

All bases mentioned so far were designed to be capable of being used several times. After production of the plaster cast, the bases were used for inserting the plaster cast into articulators and reproducing the movement of the patient's denture with the aid of the articulators and thus enabling the dental technician to produce a correct dental prosthesis or correctly functioning artificial teeth, crowns, inlays or the like.

The articulators were likewise designed for repeated use and the object of all of them was to guide the upper denture relative to the lower denture in the same way as was possible by means of the temporomandibular joint of the respective patient, both with respect to the opening/closing movement and with respect to a lateral displaceability of the upper denture relative to the lower denture.

Complicated methods for establishing the actual situation in the respective patient and setting it up in the articulator were provided. Measuring instruments which were fixed to a patient's nose, ears and jaw determined the position and function of the temporomandibular joint. This measured position was then reconstructed on the articulator with the intention of enabling the dental technician to reproduce the real situation as exactly as possible on a model. Since in particular the measurement was unpleasant for the patient and too time-consuming for the dentist, it was often dispensed with and a middle position of the joint which suited a large group of people was taken as the starting point. Consequently, the tooth models and the teeth or tooth parts produced therewith were more or less accurate.

In the USA, a disposable system which was produced from plastic and remained on the tooth model until disposal even appeared for articulators.

However, there were also simpler articulators which were used for preparing models of rows of teeth on one side. These articulators are supplied by Girrbach in Germany, for example under the name YSB. These stable crowns and bridge model holders have a spring-actuated pivot axle which can be moved to a small extent in a lateral path in order to permit approximately an—unadjustable and average—movement of the upper denture relative to the lower denture for the dental technician. The lateral path is also oriented according to an estimated average temporomandibular joint position.

In contrast to the base systems described above, the YSB articulator provides edge guidance for the tooth models by virtue of the fact that a pan-like recess having ribs on the wall permits positioning and repositioning of model parts. For removal of models, a wall of the pan can be swivelled away laterally. On insertion of the model parts, they are inserted from above into the closed pan and the ribs ensure positioning.

A disadvantage of this is that any plaster residues or the like may remain as impurities at the bottom of the pan and may prevent correct (height) positioning of the plaster cast parts there. If the dental technician does not detect such an obstruction in good time, this leads to the production of incorrect dental prosthesis parts. Another disadvantage is the limited mobility of the pivot axle in its lateral path.

On the other hand, articulators having model holders which, instead of clamping a base in a pan, fix the base by means of magnetic force at defined locking points have become known. Such a design has been disclosed, for example, in WO-A-86/3959 (Amann model).

Starting from this relatively broad and complex prior art, it is the object of the invention to provide a novel base and a novel articulator which are intended to permit an improvement for the dental technician's work sequence and an increase in the accuracy of production during the production of dental prosthesis parts.

Denture models should furthermore be capable of being produced with a dimensionally stable, prefabricated baseplate in a time-saving and hence economical manner.

This object is achieved, according to the invention, by the characterizing features of claim 1.

The invention is based on the discovery that the Wohlwend model in most cases permits good guidance of the model but, in the case of very small model parts, there is the danger that the pins offer too little guidance.

These disadvantages were eliminated by the guide rail. In the context of the invention, guide rail is to be understood as meaning both grooves and ribs which permit a diametrically opposite formation in each case in the plaster cast.

Furthermore, an attempt was made to avoid the stated observation of the problems due to impurities in pan-like receiving containers by ensuring that the pan itself only temporarily has sidewalls so that, if required, the bottom of the baseplate does not rest on the bottom of the pan but can be removed therefrom or can be completely freed from the walls.

Thus, plaster residues, abrasion material or the like cause no problems or can be readily removed.

The individual tooth stumps can therefore be replaced several times on the baseplate without any fear of inaccuracies between the wall sections on the baseplate and the guide surfaces in the model.

In comparison with the known embodiments comprising the retaining pins (Wohlwend model), the guidance of the tooth stumps is decisively improved owing to the additional rails and/or owing to the displaceable walls and the consequent additional guide surfaces.

Moreover, the method of production is simplified because all parts of the baseplate according to the invention are components which can be easily produced and can be used in different articulators.

U.S. Pat. No. 3,581,398 discloses a denture model in which, instead of individual pins, a guide web is provided for the model. However, this web is nondetachably anchored in the model and detachably guided on the base, which partly consists of a curable material and not just of a prefabricated baseplate and thus has to be additionally produced in each case. Thus, no guide surfaces are formed during curing of the plaster of Paris.

The known Zeiser model also has a variant in which, next to a passage, a web projects perpendicularly from a base surface of the baseplate, the wall of which web is used as a guide, but this web does not cooperate with the pins which are provided according to the invention and, in a specific case, form a type of pivot bearing for a tooth model part, the rotational movement being prevented by the rail according to the invention.

The baseplate can be produced from various materials, such as, for example, plastic, aluminium, stainless steel or the like.

A preferred embodiment of the invention provides an articulator which completely departs from the previously dominant concept of attempting to reproduce the temporomandibular joint situation in a realistic manner and instead attempts to find a positioning of the upper denture model which permits free mobility of the tooth models relative to one another, free mobility meaning mobility along the engaging cusps. Thus, it is not the (arbitrarily) specified temporomandibular joint situation which should dominate but the actual (nonarbitrary) cusp situation of the teeth.

The invention and further advantageous embodiments are explained in more detail below with reference to the working examples shown in the drawings.

By way of example:

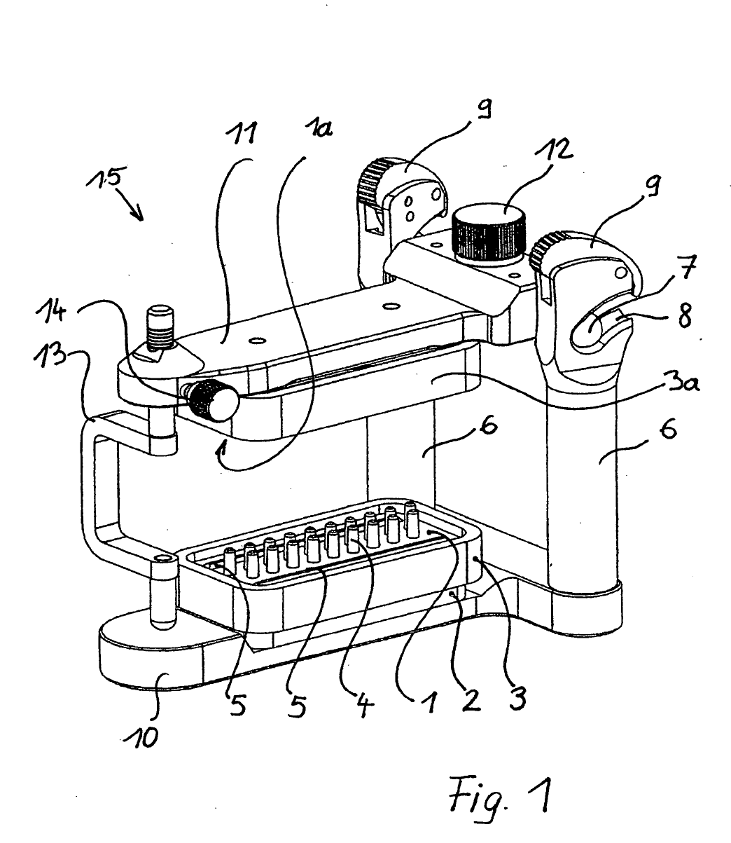

FIG. 1 shows an oblique view of a baseplate in an articulator according to the invention;

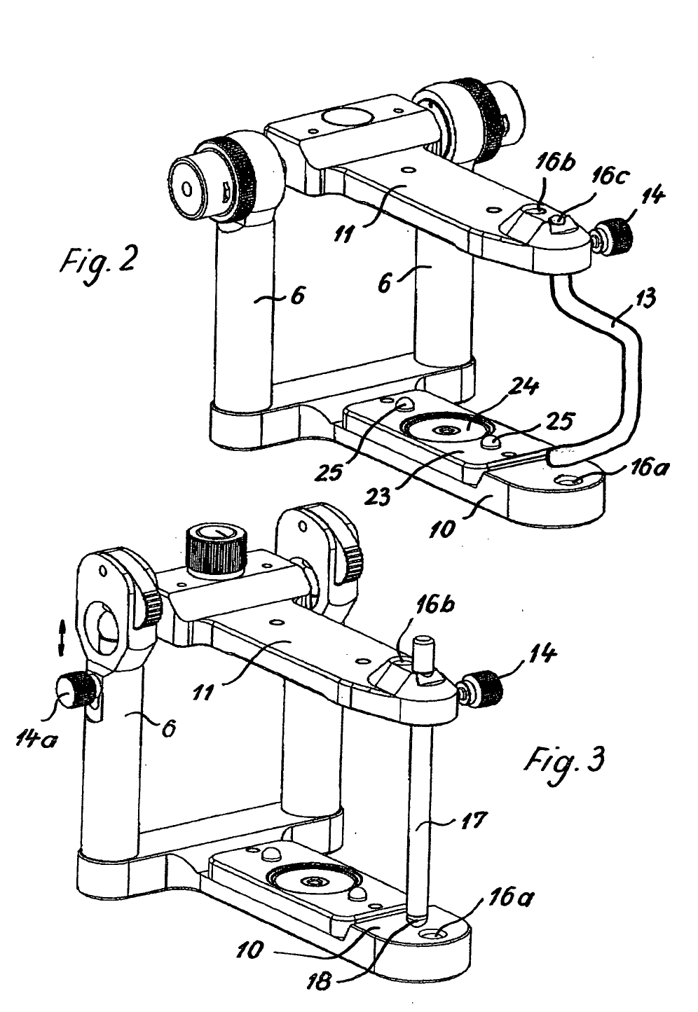

FIG. 2 shows an embodiment according to the invention as in FIG. 1, having a C-shaped support bracket and with baseplate removed;

FIG. 3 shows an embodiment according to the invention, of an articulator according to the preceding figures, having a straight pin on the incisal side;

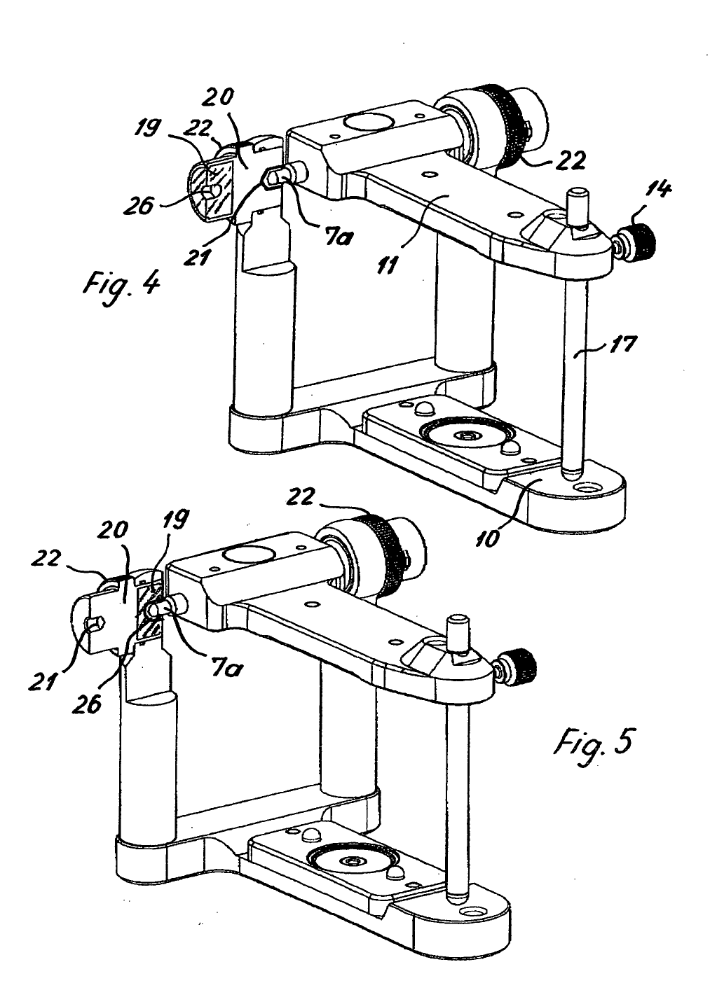

FIG. 4 shows an embodiment, according to the invention, of an articulator according to the preceding figures, having a differently mounted pivot axle, in this case in the fixed bearing position;

FIG. 5 shows a schematic diagram of an articulator according to the invention, the pivot axle resting in a rubber-mounted bearing here;

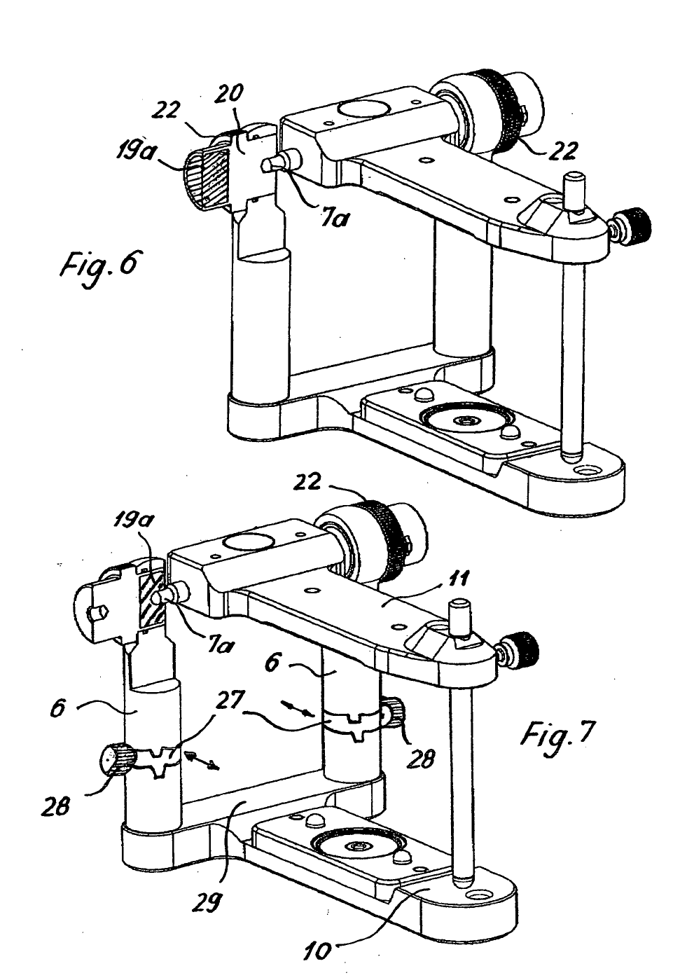

FIG. 6 shows a view of the interchangeable component with a rubber bearing without guide groove and

FIG. 7 shows a view with adjustable columns.

FIG. 1 schematically shows that a baseplate 1 having a substantially rectangular contour which approximately corresponds to the shape of a one-sided denture model is produced as an integral unit from a dimensionally stable plastic or metal.

An annular guide jacket 3 for lateral fixing of a plaster cast on the baseplate 1 is present around its lateral surface 2.

In the middle, the baseplate 1 has two rows of pins 4 with a conical contour which produce diametrically opposite recesses in the plaster cast which serve as positioning aids. Two longitudinal ribs 5 which, in cooperation with the pins, permit subsequent exact positioning of the plaster cast parts, are present on the baseplate 1 to assist with positioning.

Instead of two rows of pins 4, it is also possible to provide more or fewer rows. Instead of ribs 5, it would also be possible to provide grooves.

The guide jacket 3 fits on the lateral surfaces and is self-locking but can be moved along said surfaces or removed so that the plaster cast also rests completely freely on the baseplate 1.

In addition to the removal baseplate 1, the articulator has a bottom 10 which, in the embodiment shown, has an approximately congruent contour with the baseplate 1 and serves as a base for the articulator. The baseplate 1 is detachable from the bottom 10 by means of a manipulation, since it is only pushed on there. Preferably and in a manner known per se (Amann model), the baseplate 1 is held on the base 10 by means of a magnetic clamp 24 and guide pins 25.

The bottom carries two guide columns 6 which support a pivot axle 7. Preferably, the bearing point is in the form of a curved lateral path 8 which permits free mobility of the pivot axle 7. In contrast to conventional lateral paths, the present path is not oriented to the temporomandibular joint but to the tooth cusps of the individual patient and may therefore differ from patient to patient. In the present case, a path having a mean value orientation is shown. The pivot axle 7 is spherical at its ends so that it slides readily in the lateral path 8. A snap closure 9 permits locking of the pivot axle 7.

The pivot axle 7 supports a flap 11 which has fastening means of the same type for a baseplate 1a for the upper denture model. The baseplate 1a likewise carries a guide jacket 3a. A fixing screw 12 permits rigid connection of the pivot axle 7 to the flap 11. Undoing the fixing screw 12 permits lateral displacement of the flap 11 on the pivot axle 7. The flap 11 is thus optimally movable relative to the bottom 10. The flap corresponds in its contours approximately to the bottom 10.

In the front region, the flap 11 is supported on the bottom 10 by means of support bracket 13. The support bracket 13 is adjustable in height and can be clamped by means of screw 14. The parts 6 to 14 form the articulator 15.

FIG. 2 shows an articulator which is equipped with a C-shaped support bracket 13 which can also be positioned in recesses other than 16c, namely 16a and 16b, and from both directions, so that the support bracket 13 also supports the swivelled-back flap 11 in an approximately horizontal position. Furthermore, this drawing shows that the baseplates rest on magnetic holders 23 with a magnet 24 and guide pins 25.

FIG. 3 shows a metal pin 17 which is adjustable in height by means of clamping screw 14 and is provided at one end with a plastic tip 18.

The column 6 is adjustable in height by means of the clamping screw 14a.

FIG. 4 shows that the pivot axle 7a is not spherical but may also be designed in the form of a journal and is located in a fixed bearing 21. The component 20 is preferably in the form of an interchangeable component, the present sectional diagram of which shows that one side provides a fixed bearing 21 and the other side rubber bearing 19. This flexible bearing 19 can be produced from rubber or from other materials having similar properties. In the embodiment shown, the rubber bearing 19 is provided with a groove 26 for receiving the journal-like pivot axle 7a.

The respectively chosen mounting by means of the interchangeable component 20 is locked by means of the lock which can preferably be designed as a bayonet socket.

FIG. 5 shows the other position of the interchangeable component 20.

FIG. 6 shows a further embodiment of the invention, in which, for arbitrary positioning of the pivot axle 7a along the perpendicular, for example, the bearing 19a consists of two halves which are clamped to one another by means of the lock 22. For this purpose, the two halves of the bearing 19a are no longer provided with a groove 26, thus resulting in good possibilities for adjustment of the pivot axle 7a in height.

FIG. 7 shows that the columns 6 can be held so as to be positionable in the horizontal direction by means of a slide 27 and a locking screw 28. Thus, not only is adjustment of the pivot axle 7a in height ensured, as shown in FIG. 6, but also in the horizontal direction.

A further embodiment of the invention envisages not firmly connecting the columns 6 to one another by means of connecting base 29 but holding each column so that it can be positioned independently along a rail in the bottom 10.

For the production of the denture model, an impression of the denture is first produced in a known manner by means of a tray open at the top and bottom and is filled with a material, for example an epoxy plastic or plaster. The baseplate 1 is placed under this impression of the dentures. The baseplate 1a of the same design is placed on this impression of the denture from above, resulting in automatic orientation of the impressions of the tooth rows or of the plaster casts resulting therefrom. Orientation in a particular working apparatus can be dispensed with. After curing of the moulding material, the latter adheres to the baseplates 1 and 1a so that they can be introduced into the articulator 15 and further processed.

According to a preferred embodiment of the present invention, the articulator is equipped with a C-shaped support pin which is secured by means of an O-ring to prevent it from falling out accidentally. This O-ring comprises a nonslip material and is fitted into a groove.

Further embodiments of the invention are stated in the Patent Claims.

### List of Reference Numerals

1, 1a Baseplate
2 Sidewall of baseplate 1, 1a
3 Guide jacket
4 Pin
5 Rail
6 Column
7 Pivot axle
8 Lateral path
9 Catch
10 Bottom
11 Flap
12 Fixing screw
13 Support bracket
14 Clamping screw
15 Articulator
16a, b, c recess
17 Metal pin
18 Plastic tip
19 Rubber-mounted bearing
20 Interchangeable component
21 Fixed bearing
22 Lock
23 Magnetic holder
24 Magnet
25 Guide pin
26 Groove
27 Slide
28 Locking screw
29 Connecting base

1. Base for a denture model and articulator (15) for preparing dental prosthesis parts, such as cast inlay fillings, crowns, bridges, prosthetic dentures and the like, in which positive reproductions of teeth or rows of teeth can be fixed on a dimensionally stable baseplate (1, 1a), guide elements (3, 4, 5) being provided on the baseplate (1, 1a) and the articulator (15) having a bottom (10) and a flap (11), each for receiving a baseplate (1, 1a), and the flap (11) being movable relative to the bottom (10) and connected via a pivot axle (7), characterized in that, as guide elements, at least one dimensionally stable rail (5) and at least one row of pins (4) parallel thereto are firmly connected to the baseplate (1, 1a) and form corresponding guide surfaces at the tooth stumps during curing of the moulding material of the denture models.

2. Base according to claim 1, characterized in that a displaceable or removable guide jacket (3) is provided as an additional guide element on the sidewalls (2) of the baseplate (1, 1a).

3. Base according to claim 1, characterized in that the guide jacket is produced from a plastic having low surface adhesion or surface roughness, preferably from a plastic such as, for example, Teflon® or the like.

4. Base according to claim 1, characterized in that at least two rows of pins (4), which are preferably arranged in gaps, are provided.

5. Base according to claim 1, characterized in that the baseplate (1) is produced from metal, in particular aluminium, and that the rail (5) is formed integrally with the plate.

6. Base according to claim 5, characterized in that the at least one rail (5) is in the form of a groove or in the form of a rib.

7. Base according to claim 1, characterized in that the baseplate (1, 1a) can be connected to the bottom (10) or to the flap (11) by means of a magnetic holder.

8. Base with articulator (15) according to claim 1, characterized in that the flap (11) is removably connected to the bottom (10) via a pivot axle (7).

9. Base according to claim 8, characterized in that the flap (11) is displaceable relative to the pivot axle (7) and can be locked on the latter.

10. Base according to claim 8, characterized in that at least one lateral path (8), the shape of which is preferably tailored to the tooth cusps of the denture model, is coordinated with the pivot axle (7) in a component fixed to the bottom.

11. Base according to claim 8, characterized in that the ends of the pivot axle (7) which each rest against a lateral path (8) are spherical.

12. Base according to claim 8, characterized in that the pivot axle (7) can be locked in the lateral paths (8) by means of catch member (9).

13. Base according to claim 1, characterized in that the lateral path (8a) is adjustable in height relative to the bottom (10).

14. Base according to claim 1, characterized in that the lateral path (8a) is spherical.

15. Base according to claim 1, characterized in that the lateral path (8a) is replaced by a rubber-mounted bearing (19) or bearing (19) mounted using a material having similar properties.

16. Base according to claim 1, characterized in that the bearing (19) is installed in an interchangeable component (20) which has a fixed bearing (21) at its other end, either the rubber-mounted bearing (19) or the fixed bearing (21) being capable of being made to engage the pivot axle (7a).

17. Base according to claim 1, characterized in that the interchangeable component (20) can be locked by means of a lock (22), preferably having a bayonet socket.

18. Base according to claim 1, characterized in that the bearing (19) has two planar clamping surfaces.

19. Base according to claim 1, characterized in that the columns (6) can be displaceably positioned in the perpendicular and/or the horizontal direction.

20. Base according to claim 1, characterized in that the baseplate (1, 1a) is coloured or black in order to permit good contrast with moulding material residues.

21. Base according to claim 1, characterized in that a support device (13) which is approximately C-shaped or has a bulge is provided, so that the path for operability of the baseplate (1, 1a) is free, in particular on the incisal side.

22. Base according to claim 1, characterized in that a support device (13) which can be adjustably positioned as desired on a central axle of the articulator (15) to the left or right or along an extension of the central axle of the articulator (15) and can be laterally rotated is provided.

23. Base according to claim 1, characterized in that a support device (13) which can be fastened both in the bottom (10) and optionally in the flap (11) is provided.

24. Base according to claim 1, characterized in that a support device (13) which can be fastened both on the underside and on the top of the flap (11) is provided.

25. Base according to claim 1, characterized in that a support device (13) which can be fastened on the top of the flap (11) is provided, so that the swivelled-back flap (11) can be supported in an approximately horizontal or horizontal position.

26. Base according to claim 1, characterized in that the support device (13) can be inserted into a recess (16a) in the bottom (10) or into one of the recesses (16b, c) in the flap (11), and that the support device (13) is preferably secured by means of an O-ring of nonslip material to prevent it from falling out accidentally.

27. Base according to claim 1, characterized in that the support device (13) is provided in the form of an incisal metal pin (17) whose end with which it is supported on the bottom (10) is provided with a plastic tip (18).

28. Base according to claim 1, characterized in that the support device (13) is adjustable in height.
